(19) United States
(12) Patent Application Publication
(10) Pub. No.: US 2008/0204634 A1
(43) Pub. Date: Aug. 28, 2008

(54) Optical Laminate

(75) Inventor: Tomoyuki Horio, Okayama-Ken (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 11/885,700

(22) PCT Filed: Mar. 29, 2006
(86) PCT No.: PCT/JP2006/306511

§ 371 Date: Mar. 25, 2008

(30) Foreign Application Priority Data
Mar. 30, 2005 (JP) 2005-098586

(51) Int. Cl. G02F 1/1335; C08F 292/00

(52) U.S. Cl. 349/96; 524/438

(57) ABSTRACT

The present invention discloses an optical laminate which could have realized effective prevention of the occurrence of interfacial reflection and interference fringes by rendering the interface of the light transparent base material and the hard coat layer absent. The present invention is that the optical laminate comprises a light transparent base material and a hard coat layer provided on the light transparent base material, wherein the hard coat layer comprises a resin, a contamination preventive agent, and a penetrating solvent which is penetrable into (can swell or dissolve) the light transparent base material, whereby the interface of the light transparent base material and the hard coat layer has been rendered absent.

### BACKGROUND OF THE INVENTION

### CROSS-REFERENCE TO RELATED APPLICATIONS

This application is based upon and claims the benefit of priority from the prior Japanese Patent Applications No. 98586/2005 under the Paris Convention, and, thus, the entire contents thereof are incorporated herein by reference.

1. Technical Field

The present invention provides an optical laminate which could have realized excellent contamination preventive properties and the prevention of interfacial reflection and interference fringes.

2. Background Art

A reduction in reflection of light applied from an external light source and an enhancement in the visibility of image are required of an image display face in image display devices such as liquid crystal displays (LCDs) or cathode ray tube display devices (CRTs). On the other hand, it is common practice to reduce the reflection from the image display face in the image display device and thus to improve the visibility by utilizing an optical laminate (for example, an antireflection laminate) comprising an antireflection layer provided on a light transparent base material.

In the optical laminate comprising layers, which are significantly different from each other in refractive index, stacked on top of each other, interface reflection and interference fringes often occur in the interface between the mutually superimposed layers. In particular, it has been pointed out that interference fringes are significant in the reproduction of a black color on the image display face of an image display device and, consequently, the visibility of the image is lowered and, at the same time, the appearance of the image on the image display face is deteriorated. In this connection, it is particularly said that, when the refractive index of the light transparent base material is different from the refractive index of the hard coat layer, interference fringes are likely to occur. Japanese Patent Laid-Open No. 131007/2003 proposes an optical film characterized in that, in order to suppress the occurrence of interference fringes, the refractive index around the interface of the base material and the hard coat layer is continuously changed.

Further, it has been pointed out that the image display face is exposed to various service environments and thus is likely to be scratched and contaminated. To overcome this drawback, Japanese Patent Laid-Open No. 104403/1998 proposes an optical laminate comprising a hard coat layer in which a contamination preventive agent has been added to the hard coat layer from the viewpoint of improving the scratch resistance and contamination prevention of the image display face.

So far as the present inventors know, however, up to now, any optical laminate has not been proposed in which the state of interface between the light transparent base material and the hard coat layer has been substantially eliminated and, at the same time, both a high strength of the hard coat layer and the contamination preventive property could have been simultaneously realized.

At the time of the present invention, the present inventors have aimed at the state of the interface of the light transparent base material and the hard coat layer and, as a result, have found that an optical laminate substantially free from the interface of the light transparent base material and the hard coat layer can be provided. Further, at the time of the present invention, the present inventors have found that the addition of a contamination preventive agent to the hard coat layer according to the present invention can improve both the scratch resistance and the contamination preventive property. Accordingly, the present invention provides an optical laminate which could have realized effective prevention of the interface reflection and interference fringes and has improved visibility and mechanical strength by eliminating the interface of the light transparent base material and the hard coat layer and, at the same time, has scratch resistance and contamination preventive properties.

Thus, according to the present invention, there is provided
an optical laminate comprising a light transparent base material and a hard coat layer provided on the light transparent base material, wherein
the hard coat layer has been formed using a composition comprising a resin, a contamination preventive agent, and a penetrating solvent penetrable into the light transparent base material, whereby the interface of the light transparent base material and the hard coat layer has been rendered absent.

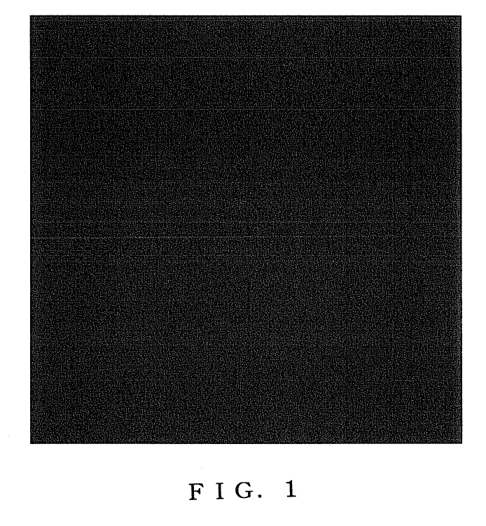

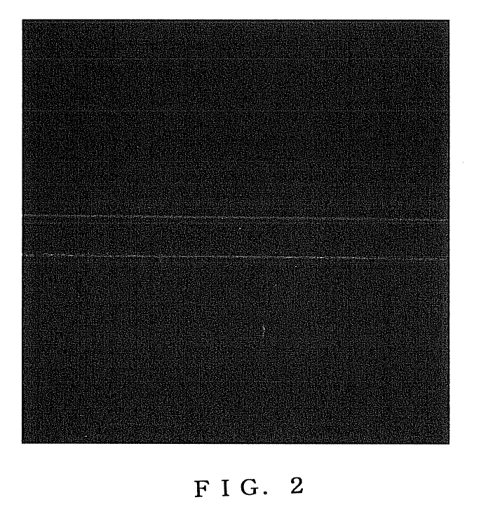

### BRIEF DESCRIPTION OF THE DRAWINGS

[FIG. 1] FIG. 1 is a laser photomicrograph of the cross section of an optical laminate according to the present invention.

[FIG. 2] FIG. 2 is a laser photomicrograph of the cross section of a comparative optical laminate.

### BEST MODE FOR CARRYING OUT THE INVENTION

1. Optical laminate

### Substantial Elimination of Interface

In the optical laminate according to the present invention, the interface is substantially absent between the light transparent base material and the hard coat layer. In the present invention, the expression “interface is (substantially) absent” means that there is no interface although two layer faces are superimposed on top of each other, and further connotes that, based on the refractive index value, the interface is judged to be absent between both the layer faces. A specific example of a criterion based on which the “interface is (substantially) absent” is that, when visual observation of the cross section of the optical laminate under a laser microscope shows the presence of interference fringes, the interface is judged to be present, while, when visual observation of the cross section of the optical laminate under a laser microscope shows the absence of interference fringes, the interface is judged to be absent. The laser microscope can observe the cross section of materials different in refractive index in a nondestructive manner. Accordingly, in the case of materials having no significant difference in refractive index therebetween, the results of the measurement show that there is no interface between these materials. Therefore, it can also be judged based on the refractive index that there is no interface between the base material and the hard coat layer.

Hard coat layer

The term “hard coat layer” as used herein refers to a layer having a hardness of “H” or higher as measured by a pencil hardness test specified in JIS K 5600-5-4 (1999). The thickness (in a cured state) of the hard coat layer is 0.1 to 100 μm, preferably 0.8 to 20 μm. The hard coat layer comprises a resin and optional components.

Resin

In the present specification, curable resin precursors such as monomers, oligomers, and prepolymers are collectively referred to as “resin” unless otherwise specified. The resin is preferably transparent, and specific examples thereof are classified into ionizing radiation curing resins which are curable upon exposure to ultraviolet light or electron beams, mixtures of ionizing radiation curing resins with solvent drying-type resins (resins which are formed into films by merely removing a solvent, added for regulating the solid content in the coating, by drying, for example, thermoplastic resins), or heat curing resins. Preferred are ionizing radiation curing resins.

Specific examples of ionizing radiation curing resins include those containing an acrylate-type functional group, for example, oligomers or prepolymers and reactive diluents, for example, relatively low-molecular weight polyester resins, polyether resins, acrylic resins, epoxy resins, urethane resins, alkyd resins, spiroacetal resins, polybutadiene resins, and polythiol polyene resins and (meth)acrylates of polyfunctional compounds such as polyhydric alcohols.

When ionizing radiation curing resins are used as an ultraviolet curing resin, preferably, a photopolymerization initiator is used. In the case of the radical polymerizable unsaturated group-containing resin system, specific examples of photopolymerization initiators include acetophenones, benzophenones, Michler's benzoyl benzoate, α-amyloxime ester, tetramethyl thiuram monosulfide, thioxanthones, propiophenones, benzyls, benzoins, and acylphosphine oxidos. On the other hand, in the case of a cation polymerizable functional group-containing resin system, aromatic diazonium salts, aromatic sulfonium salts, aromatic idonium salts, metallocene compounds, benzoinsulfonic esters and the like may be used as a photopolymerization initiator either solely or as a mixture of two or more. The amount of the photopolymerization initiator added is 0.1 to 10 parts by weight based on 100 parts by weight of the ionizing radiation curing composition. Preferably, photosensitizers are mixed in the system. Specific examples of photosensitizers include n-butylamine, triethylamine, and poly-n-butylphosphine.

The solvent drying-type resin (resins which are formed into films by merely removing a solvent, added for regulating the solid content in the coating, by drying) used as a mixture with the ionizing radiation curing resin is mainly a thermoplastic resin. Commonly exemplified thermoplastic resins are usable. Coating defects of the coated face can be effectively prevented by adding the solvent drying-type resin. In a preferred embodiment of the present invention, when the light transparent base material is formed of a cellulosic resin such as triacetylcellulose “TAC,” specific examples of preferred thermoplastic resins include cellulosic resins, for example, nitrocellulose, acetylcellulose, cellulose acetate propionate, and ethylhydroxyethylcellulose. In a more preferred embodiment of the present invention, preferred thermoplastic resins include, for example, styrenic resins, (meth)acrylic resins, vinyl acetate resins, vinyl ether resins, halogen-containing resins, alicyclic olefinic resins, polycarbonate resins, polyester resins, polyamide resins, cellulose derivatives, silicone resins, and rubbers or elastomers. Resins, which are usually noncrystalline and soluble in organic solvents (particularly common solvents which can dissolve a plurality of polymers or curable compounds), may be used. Particularly preferred are, for example, resins having a high level of moldability or film formability, transparency and weathering resistance, for example, styrenic resins, (meth)acrylic resins, alicyclic olefinic resins, polyester resins, and cellulose derivatives (for example, cellulose esters).

Specific examples of heat curing resins include phenolic resins, urea resins, diallyl phthalate resins, melanin resins, guanamine resins, unsaturated polyester resins, polyurethane resins, epoxy resins, aminoalkyd resins, melamine-urea cocondensed resins, silicone resins, and polysiloxane resins. When the heat curing resin is used, if necessary, for example, curing agents such as crosslinking agents and polymerization initiators, polymerization accelerators, solvents, and viscosity modifiers may be further added.

2) Penetrating solvent

A solvent penetrable into the light transparent base material is utilized. Accordingly, in the present invention, the term “penetrability” in the penetrating solvent embraces all concepts of penetrating, swelling, wetting and other properties in relation to the light transparent base material. Specific examples of penetrating solvents include alcohols such as isopropyl alcohol, methanol, and ethanol; ketones such as methyl ethyl ketone, methyl isobutyl ketone, and cyclohexanone; esters such as methyl acetate, ethyl acetate, and butyl acetate; halogenated hydrocarbons such as chloroform, methylene chloride, and tetrachloroethane; or their mixtures. Preferred are esters and ketones.

Specific examples of penetrating solvents include acetone, methyl acetate, ethyl acetate, butyl acetate, chloroform, methylene chloride, trichloroethane, tetrahydrofuran, methyl ethyl ketone, methyl isobutyl ketone, cyclohexanone, nitromethane, 1,4-dioxane, dioxolane, N-methylpyrrolidone, N,N-dimethylformamide, methanol, ethanol, isopropyl alcohol, butanol, isobutyl alcohol, diisopropyl ether, methylcellosolve, ethylcellosolve, and butylcellosolve. Preferred are methyl acetate, ethyl acetate, butyl acetate, methyl ethyl ketone and the like.

Specific examples of preferred penetrating agents include ketones such as acetone, methyl ethyl ketone, cyclohexanone, methyl isobutyl ketone, and diacetone alcohol; esters such as methyl formate, methyl acetate, ethyl acetate, butyl acetate, and ethyl lactate; nitrogen-containing compound such as nitromethane, acetonitrile, N-methylpyrrolidone, and N,N-dimethylformamide; glycols such as methyl glycol, and methyl glycol acetate; ethers such as tetrahydrofuran, 1,4-dioxane, dioxolane, and diisopropyl ether; halogenated hydrocarbon such as methylene chloride, chloroform, and tetrachloroethane; glycol ethers such as methylcellosolve, ethylcellosolve, butylcellosolve, and cellosolve acetate; and other solvents such as dimethyl sulfoxide and propylene carbonate; or mixtures thereof. Preferred are esters and ketones, for example, methyl acetate, ethyl acetate, butyl acetate, and methyl ethyl ketone.

3) Contamination preventive agent

Contamination preventive agents include fluorine-type compounds, silicon-type compounds, or mixed compound thereof. In the present invention, in order to improve the durability of the contamination preventive properties, compounds containing a reactive group (a monofunctional or higher group, preferably a difunctional or higher group) are preferred. When a reactive group-containing contamination preventive agent is used, upon the compolymerization of a composition for a hard coat layer, for example, by ultraviolet light, heat or electron beams, the contamination preventive agent is also copolymerized resulting in the presence of the contamination preventive agent within the hard coat layer in a bonded state rather than in a free state. As a result, even when the removal of the contaminant on the surface of the hard coat layer is repeatedly carried out by washing, the contamination preventive agent is not separated or dropped out and, thus, the contamination preventive effect can be maintained semipermanently. Further, the hardness of the hard coat layer (scratch resistance) can be improved. Furthermore, in the production process, a problem of transfer contamination of other layer or a winding roll or the like with the contamination preventive agent can be eliminated. In the present invention, the contamination preventive agent containing a reactive group is preferably (meth)acrylate.

In the present invention, the reactive contamination preventive agent which is preferably utilized is commercially available, and examples thereof include SUA 1900L10 (weight average molecular weight 4200; manufactured by Shin-Nakamura Chemical Co., Ltd.), SUA 1900L6 (weight average molecular weight 2470; manufactured by Shin-Nakamura Chemical Co., Ltd.), Ebecryl 1360 (manufactured by Daicel UCB Co.), UT 3971 (manufactured by The Nippon Synthetic Chemical Industry Co., Ltd.), Diffencer TF 3001 (manufactured by Dainippon Ink and Chemicals, Inc.), Diffencer TF 3000 (manufactured by Dainippon Ink and Chemicals, Inc.), Diffencer TF 3028 (manufactured by Dainippon Ink and Chemicals, Inc.), KRM 7039 (manufactured by Daicel UCB Co.), and LIGHT PROCOAT AFC 3000 (manufactured by Kyoeisha Chemical Co., Ltd.). In the present invention, other reactive contamination preventive agents are commercially available, and examples thereof include KNS 5300 (manufactured by Shin-Etsu Silicone), UVHC 1105 (manufactured by GE Toshiba Silicones), UVHC 8850 (manufactured by GE Toshiba Silicones), Ebecryl 350 (manufactured by Daicel UCB Co.), and ACS-1122 (manufactured by Nippon Paint Co., Ltd.).

When the contamination preventive agent is an organic compound, the number average molecular weight is not less than 500 and not more than 100,000. Preferably, the lower limit of the number average molecular weight is 750, more preferably 1000, and the upper limit of the number average molecular weight is 70,000, more preferably 50,000.

The addition amount of the contamination preventive agent is not less than 0.001 part by weight and not more than 90 parts by weight based on the total weight of the composition for hard coat layer formation. Preferably, the lower limit of the addition amount of the contamination preventive agent is 0.01 part by weight, more preferably 0.1 part by weight, and the upper limit of the addition amount of the contamination preventive agent is 70 parts by weight, more preferably 50 parts by weight. The addition amount of the contamination preventive agent in the above-defined range can effectively realize the contamination preventive property, can improve the coatability onto the base material, and further can effectively prevent coloration of the laminate. Accordingly, the addition amount of the contamination preventive agent in the above-defined range is advantageous in that satisfactory contamination preventive functions can be realized, and the hardness of the optical laminate is satisfactory.

In a preferred embodiment of the present invention, the contamination preventive agent contains a difunctional or higher polyfunctional (meth)acrylate group containing a polyorganosiloxane group, a polyorganosiloxane-containing graft polymer, a polyorganosiloxane-containing block copolymer, a fluorinated alkyl group or the like. In the present invention, the (meth)acrylate group-containing monomer, oligomer, prepolymer, polymer and the like are collectively referred to as (meth)acrylate. Polyfunctional acrylates include, for example, difunctional acrylates, for example, tripropylene glycol di(meth)acrylate, polypropylene glycol di(meth)acrylate, diethylene glycol di(meth)acrylate, polyethylene glycol di(meth)acrylate, 1,3-butanediol di(meth)acrylate, 1,4-butanediol di(meth)acrylate, ethoxylated bisphenol A di(meth)acrylate, ethoxylated bisphenol F di(meth)acrylate, 1,6-hexanediol di(meth)acrylate, 1,9-nonanediol di(meth)acrylate, 1,10-decanediol di(meth)acrylate, glycerin di(meth)acrylate, neopentyl glycol di(meth)acrylate, propoxylated neopentyl glycol di(meth)acrylate, pentaerithritol diacrylate monostearate, isocyanuric acid ethoxy-modified di(meth)acrylate (isocyanuric acid EO-modified di(meth)acrylate), difunctional urethane acrylate, and difunctional polyester acrylate. Trifunctional acrylates include, for example, pentaerithritol tri(meth)acrylate, trimethylolpropane tri(meth)acrylate, trimethylolpropane EO-modified tri(meth)acrylate, isocyanuric acid EO-modified tri(meth)acrylate, ethoxylated trimethylolpropane tri(meth)acrylate, propoxylated trimethylolpropane tri(meth)acrylate, propoxylated glyceryl tri(meth)acrylate, and trifunctional polyesteracrylate. Tetrafunctional acrylates include, for example, pentaerithritol tetra(meth)acrylate, ditrimethylolpropane tetra(meth)acrylate, and ethoxylated pentaerithritol tetra(meth)acrylate. Pentafunctional or higher acrylates include dipentaerithritol hydroxy penta(meth)acrylate and dipentaerithritol hexaacrylate. Further, hexafunctional, nonafunctinal, decafunctional, dodecafunctional, pentadecafunctional or other functional group-containing urethane (meth)acrylates may also be mentioned.

### Tri- or Higher Polyfunctional (Meth)Acrylate

In a preferred embodiment of the present invention, the composition for hard coat layer formation further comprises a tri- or higher functional polyfunctional acrylate. Specific examples of tri- or higher functional (meth)acrylates may be the same as those described above in connection with the contamination preventive agent.

The addition amount of the tri-or higher polyfunctional (meth)acrylate is not less than 10 parts by weight and not more than 99.999 parts by weight based on the total weight of the composition for hard coat layer formation. Preferably, the lower limit of the addition amount of the tri- or higher polyfunctional (meth)acrylate is 30 parts by weight, more preferably 50 parts by weight. Preferably, the upper limit of the addition amount of the tri- or higher polyfunctional (meth)acrylate is 99.99 parts by weight, more preferably 99.9 parts by weight.

4) Antistatic agent and/or anti-dazzling agent

Preferably, the hard coat layer according to the present invention contains an antistatic agent and/or an anti-dazzling agent.

Antistatic agent (electroconductive agent)

Specific examples of antistatic agents for antistatic layer formation include cationic group-containing various cationic compounds such as quaternary ammonium salts, pyridinium salts, primary, secondary and tertiary amino groups, anionic group-containing anionic compounds such as sulfonic acid bases, sulfuric ester bases, phosphoric ester bases, and phosphonic acid bases, amphoteric compounds such as amino acid and aminosulfuric ester compounds, nonionic compounds such as amino alcohol, glycerin and polyethylene glycol compounds, organometallic compounds such as alkoxides of tin and titanium, and metal chelate compounds such as their acetylacetonate salts. Further, compounds produced by increasing the molecular weight of the above compounds may also be mentioned. Further, monomers or oligomers, which contain a tertiary amino group, a quaternary ammonium group, or a metal chelate moiety and are polymerizable upon exposure to ionizing radiations, or polymerizable compounds, for example, organometallic compounds such as coupling agents containing a functional group polymerizable upon exposure to an ionizing radiation may also be used as the antistatic agent.

Further, electroconductive ultrafine particles may be mentioned as the antistatic agent. Specific examples of electroconductive ultrafine particles include ultrafine particles of metal oxides. Such metal oxides include ZnO (refractive index 1.90; the numerical values within the parentheses being refractive index; the same shall apply hereinafter), CeO₂ (1.95), Sb₂O₂ (1.71), SnO₂ (1.997), indium tin oxide often abbreviated to “ITO” (1.95), In₂O₃ (2.00), Al₂O₃ (1.63), antimony-doped tin oxide (abbreviated to “ATO,” 2.0), and aluminum-doped zinc oxide (abbreviated to “AZO,” 2.0). The term “fine particles” refers to fine particles having a size of not more than 1 micrometer, that is, fine particles of submicron size, preferably fine particles having an average particle diameter of 0.1 nm to 0.1 μm.

In the present invention, electroconductive polymers may be mentioned as the antistatic agent, and specific examples thereof include aliphatic conjugated polyacetylenes, aromatic conjugated poly(paraphenylenes), heterocyclic conjugated polypyrroles, polythiophenes, heteroatom-containing conjugated polyanilines, and mixture-type conjugated poly(phenylenevinylenes). Additional examples of electroconductive polymers include double-chain conjugated systems which are conjugated systems having a plurality of conjugated chains in the molecule thereof, and electroconductive composites which are polymers prepared by grafting or block-copolymerizing the above conjugated polymer chain onto a saturated polymer.

Anti-dazzling agent

Fine particles may be mentioned as the anti-dazzling agent. The fine particles may be, for example, in a truly spherical or elliptical form, preferably in a truly spherical form. The fine particles may be of an inorganic type or an organic type. The fine particles exhibit anti-dazzling properties and are preferably transparent. Specific examples of fine particles include inorganic fine particles, for example, silica beads, and organic fine particles, for example, plastic beads. Specific examples of plastic beads include styrene beads (refractive index 1.59), melamine beads (refractive index 1.57), acrylic beads (refractive index 1.49), acryl-styrene beads (refractive index 1.54), polycarbonate beads, and polyethylene beads. The addition amount of the fine particles is approximately 2 to 30 parts by weight, preferably 10 to 25 parts by weight, based on 100 parts by weight of the transparent resin composition.

In preparing a composition for an anti-dazzling layer, the addition of an anti-settling agent is preferred. The addition of the anti-settling agent can realize the suppression of the settling of the resin beads and can realize uniform dispersion of the resin beads in the solvent. Specific examples of anti-settling agents include silica beads having a particle diameter of approximately not more than 0.5 μm, preferably 0.1 to 0.25 μm.

### Light Transparent Base Material

The light transparent base material may be transparent, semitransparent, colorless, or colored so far as it is transparent to light. Preferably, the light transparent base material is colorless and transparent. Specific examples of light transparent base materials include glass plates; and thin films of triacetate cellulose (TAC), polyethylene terephthalate (PET), diacetylcellulose, cellulose acetate butyrate, polyethersulfone, acrylic resin; polyurethane resin; polyester; polycarbonate; polysulfone; polyether; trimethylpentene; polyether ketone; (meth)acrylonitrile, norbornene resin and the like. In a preferred embodiment of the present invention, triacetate cellulose (TAC) is preferred as the light transparent base material. The thickness of the light transparent base material is about 30 μm to 200 μm, preferably 40 μm to 200 μm.

In a preferred embodiment of the present invention, the light transparent base material is preferably smooth and possesses excellent heat resistance and mechanical strength. Specific examples of materials usable for the light transparent base material formation include thermoplastic resins, for example, polyesters (polyethylene terephthalate and polyethylene naphthalate), cellulose triacetate, cellulose diacetate, cellulose acetatebutyrate, polyesters, polyamide, polyimide, polyethersulfone, polysulfone, polypropylene, polymethylpentene, polyvinyl chloride, polyvinylacetal, polyetherketone, polymethyl methacrylate, polycarbonate, and polyurethane. Preferred are polyesters (polyethylene terephthalate and polyethylene naphthalate) and cellulose triacetate. Films of amorphous olefin polymers (cycloolefin polymers: COPs) having an alicyclic structure may also be mentioned as other examples of the light transparent base material, and these are base materials using nobornene polymers, monocyclic olefinic polymers, cyclic conjugated diene polymers, vinyl alicyclic hydrocarbon polymer resins and the like. Examples thereof include Zeonex and ZEONOR, manufactured by Zeon Corporation (norbornene resins), Sumilight FS-1700 manufactured by Sumitomo Bakelite Co., Ltd., ARTON (modified norbornene resin) manufactured by JSR Corporation, APL (cyclic olefin copolymer) manufactured by Mitsui Chemicals Inc., Topas (cyclic olefin copolymer) manufactured by Ticona, and Optlet OZ-1000 series (alicyclic acrylic resins) manufactured by Hitachi Chemical Co., Ltd. Further, FV series (low birefringent index and low photoelastic films) manufactured by Asahi Kasei Chemicals Corporation are also preferred as base materials alternative to triacetylcellulose.

### Other Layers

As described above, the optical laminate according to the present invention basically comprises a light transparent base material and a hard coat layer provided on the light transparent base material. In view of functions or applications as the optical laminate, the following one or at least two layers may be provided on the hard coat layer.

Antistatic layer

The antistatic layer comprises an antistatic agent and a resin. The antistatic agent may be the same as that described above in connection with the hard coat layer. The thickness of the antistatic layer is preferably about 30 nm to 1 μm.

### Resin

Specific examples of resins usable herein include thermoplastic resins, heat curable resins, ionizing radiation curing resins or ionizing radiation curing compounds (including organic reactive silicon compounds). Thermoplastic resins may also be used as the resin. However, the use of heat curing resins is more preferred. The use of an ionizing radiation curing composition containing an ionizing radiation curing resin or an ionizing radiation curing compound is still more preferred.

The ionizing radiation curing composition may be a mixture prepared by properly mixing prepolymer, oligomer, and/or monomer, having a polymerizable unsaturated bond or an epoxy group in the molecule thereof, together. The ionizing radiation refers to electromagnetic waves or charged particle beams which have energy quantum high enough to polymerize or crosslink the molecule. In general, ultraviolet light or electron beam is used.

Examples of prepolymers and oligomers usable in the ionizing radiation curing composition include: unsaturated polyesters such as condensation products between unsaturated dicarboxylic acids and polyhydric alcohols; methacrylates such as polyester methacrylate, polyether methacrylate, polyol methacrylate, and melamine methacrylate; acrylates such as polyester acrylate, epoxy acrylate, urethane acrylate, polyether acrylate, polyol acrylate, and melamine acrylate; and cationically polymerizable epoxy compounds.

Examples of monomers usable in the ionizing radiation curing composition include: styrenic monomers such as styrene and α-methylstyrene; acrylic esters such as methyl acrylate, 2-ethylhexyl acrylate, methoxyethyl acrylate, butoxyethyl acrylate, butyl acrylate, methoxybutyl acrylate, and phenyl acrylate; methacrylic esters such as methyl methacrylate, ethyl methacrylate, propyl methacrylate, methoxyethyl methacrylate, ethoxymethyl methacrylate, phenyl methacrylate, and lauryl methacrylate; unsaturated substituted-type substituted amino alcohol esters such as 2-(N,N-diethylamino)ethyl acrylate, 2-(N,N-dimethylamino)ethyl acrylate, 2-(N,N-dibenzylamino)methyl acrylate, and 2-(N,N-diethylamino)propyl acrylate; unsaturated carboxylic acid amides such as acrylamide and methacrylamide; compounds such as ethylene glycol diacrylate, propylene glycol diacrylate, neopentyl glycol diacrylate, 1,6-hexanediol diacrylate, and triethylene glycol diacrylate; polyfunctional compounds such as dipropylene glycol diacrylate, ethylene glycol diacrylate, propylene glycol dimethacrylate, and diethylene glycol dimethacrylate; and/or polythiol compounds having two or more thiol groups in the molecule thereof, for example, trimethylolpropane trithioglycolate, trimethylolpropane trithiopropylate, and pentaerythritol tetrathioglycolate.

In general, one of or a mixture of two or more of the above compounds may be optionally used as the monomer in the ionizing radiation curing composition. In this case, from the viewpoint of imparting ordinary suitability for coating to the ionizing radiation curing composition, in the mixture, the content of the prepolymer or oligomer is preferably not less than 5% by weight, and the content of the monomer and/or polythiol compound is not more than 95% by weight.

When flexibility is required of a cured product of a coating of the ionizing radiation curing composition, the amount of the monomer may be reduced, or alternatively, an acrylate monomer with the number of functional groups being one or two may be used. On the other hand, when abrasion resistance, heat resistance, and solvent resistance are required of the cured product of a coating of the ionizing radiation curing composition, the ionizing radiation curing composition may be designed, for example, so that an acrylate monomer having three or more functional groups is used. Monomers having one functional group include 2-hydroxy acrylate, 2-hexyl acrylate, and phenoxyethyl acrylate. Monomers having two functional groups include ethylene glycol diacrylate and 1,6-hexanediol diacrylate. Monomers having three or more functional groups include trimethylolpropane triacrylate, pentaerythritol triacrylate, pentaerythritol tetraacrylate, and dipentaerythritol hexaacrylate.

A polymer resin not curable upon exposure to an ionizing radiation may also be added to the ionizing radiation curing composition in order to regulate properties, for example, the flexibility and surface hardness of the cured product of a coating of the ionizing radiation curing composition. Specific examples of polymer resins usable herein include thermoplastic resins such as polyurethane resins, cellulosic resins, polyvinyl butyral resins, polyester resins, acrylic resins, polyvinyl chloride resins, and polyvinyl acetate resins. The addition of polyurethane resin, cellulosic resin, polyvinylbutyral resin or the like among these resins is preferred from the viewpoint of improving the flexibility.

When the ionizing radiation curing composition is cured by ultraviolet irradiation after coating, a photopolymerization initiator or a photopolymerization accelerator may be added. Photopolymerization initiators usable in the case of a resin system having a radically polymerizable unsaturated group include acetophenones, benzophenones, thioxanthones, benzoin, and benzoin methyl ether. They may be used alone or as a mixture of two or more. On the other hand, photopolymerization initiators usable in the case of a resin system having a cationically polymerizable functional group include aromatic diazonium salts, aromatic sulfonium salts, aromatic iodonium salts, metallocene compounds, and benzoinsulfonic esters. They may be used alone or as a mixture of two or more. The amount of the photopolymerization initiator added may be 0.1 to 10 parts by weight based on 100 parts by weight of the ionizing radiation curing composition.

The following organic reactive silicon compounds may be used in combination with the ionizing radiation curing composition.

Organosilicon compounds usable herein includes those represented by general formula RₘSi(OR′)ₙ wherein R and R′ each represent an alkyl group having 1 to 10 carbon atoms and m and n are each an integer with m+n=4.

Specific examples of this type of organosilicon compounds include tetramethoxysilane, tetraethoxysilane, tetra-iso-propoxysilane, tetra-n-propoxysilane, tetra-n-butoxysilane, tetra-sec-butoxysilane, tetra-tert- butoxysilane, tetrapentaethoxysilane, tetrapenta-iso-propoxysilane, tetrapenta-n-propoxysilane, tetrapenta-n-butoxysilane, tetrapenta-sec-butoxysilane, tetrapenta-tert-butoxysilane, methyltriethoxysilane, methyltripropoxysilane, methyltributoxysilane, dimethyidimethoxysilane, dimethyidiethoxysilane, dimethylethoxysilane, dimethylmethoxysilane, dimethylpropoxysilane, dimethylbutoxysilane, methyldimethoxysilane, methyldiethoxysilane, and hexyltrimethoxysilane.

Organosilicon compounds usable in combination with the ionizing radiation curing composition is a silane coupling agent. Specific examples of silane coupling agents usable herein include
γ-(2-aminoethyl)aminopropyltrimethoxysilane,
γ-(2-aminoethyl)aminopropylmethyldimethoxysilane,
β-(3,4-epoxycyclohexyl)ethyltrimethoxysilane,
γ-aminopropyltriethoxysilane,
γ-methacryloxypropylmethoxysilane,
N-β-(N-vinylbenzylaminoethyl)-γ-aminopropylmethoxysilane hydrochloride, γ-glycidoxypropyltrimethoxysilane, aminosilane, methylmethoxysilane, vinyltriacetoxysilane,
γ-mercaptopropyltrimethoxysilane,
γ-chloropropyltrimethoxysilane, hexamethyidisilazane, vinyltris(β-methoxyethoxy)silane,
octadecyldimethyl[3-(trimethoxysilyl)propyl]ammonium chloride, methyltrichlorosilane, and dimethyldichlorosilane.

### Anti-Dazzling Layer

The anti-dazzling layer may be provided between the transparent base material and the hard coat layer or the low-refractive index layer. The anti-dazzling layer may be formed of a resin and an anti-dazzling agent. The anti-dazzling agent and the resin may be the same as those described above in connection with the hard coat layer. The thickness (in a cured state) of the anti-dazzling layer is preferably in the range of 0.1 to 100 μm, more preferably in the range of 0.8 to 10 μm. When the thickness of the anti-dazzling layer is in the above-defined range, the function as the anti-dazzling layer can be satisfactorily developed.

In a preferred embodiment of the present invention, the anti-dazzling layer simultaneously satisfies requirements represented by the following mathematical formulae:

30≦Sm≦600

0.05≦Rz≦1.60

0.1≦θa≦2.5

0.3≦R≦15

wherein R represents the average particle diameter of the fine particles, μm; Rz represents the ten-point average roughness of concavoconvexes of the anti-dazzling layer, μm; Sm represents the average spacing of concavoconvexes in the anti-dazzling layer, μm; and θa represents the average inclination angle of the concavoconvex part.

In the present invention, the definitions of Rz, Sm, and θa correspond to an instruction manual (revised on Jul. 20, 1995) of a surface roughness measuring device (model: SE-3400, manufactured by Kosaka Laboratory Ltd.). θa (degree) represents the angle mode, and, when the inclination is Δa in terms of aspect ratio, θa (degree) is determined by Δa (degree)=tanθa=(sum of values of difference between the lowest part and the highest part in each concavoconvex (corresponding to the height of each convex part)/reference length). The “reference length” refers to a measurement distance and is described as a cut-off value in the instruction manual.

In another preferred embodiment of the present invention, the anti-dazzling layer further satisfies Δn=|n1-n2|<0.1 wherein n1 and n2 represent the refractive index of the fine particles and the refractive index of the transparent resin composition, respectively. Further, preferably, the haze value of the internal part in the anti-dazzling layer is not more than 55%.

2. Production process of optical laminate

Preparation of liquid composition

Liquid compositions respectively for the antistatic layer, the thin layer, the hard coat layer and the like may be prepared by mixing the above-described components together for dispersion by a conventional preparation method. The mixing/dispersing can be properly carried out, for example, in a paint shaker or a bead mill.

Coating

Specific examples of methods for coating each liquid composition onto the surface of the light transparent base material and the surface of the antistatic layer include various methods, for example, spin coating, dip coating, spray coating, die coating, bar coating, roll coating, meniscus coating, flexographic printing, screen printing, and bead coating.

Utilization of optical laminate

The optical laminate produced by the process according to the present invention may be used as an antireflection laminate and further may be used in the following applications.

Polarizing plate

In another embodiment of the present invention, there is provided a polarizing plate comprising a polarizing element and the optical laminate according to the present invention. More specifically, there is provided a polarizing plate comprising a polarizing element and the optical laminate according to the present invention provided on the surface of the polarizing element. The polarizing plate comprises that the surface of the optical laminate remote from the anti-dazzling layer faces the surface of the polarizing element. Namely, The polarizing plate comprises that the surface of the polarizing element faces the opposite surface of the surface of the anti-dazzling layer in the optical laminate.

The polarizing element may comprise, for example, polyvinyl alcohol films, polyvinylformal films, polyvinylacetal films, and ethylene-vinyl acetate copolymer-type saponified films, which have been dyed with iodine or a dye and stretched. In the lamination treatment, preferably, the light transparent base material (preferably a triacetylcellulose film) is saponified from the viewpoint of increasing the adhesion or antistatic purposes.

Image display device

In a further embodiment of the present invention, there is provided an image display device. The image display device comprises a transmission display and a light source device for applying light to the transmission display from its back side. The optical laminate according to the present invention or the polarizing plate according to the present invention is provided on the surface of the transmission display. The image display device according to the present invention may basically comprise a light source device (backlight), a display element, and the optical laminate according to the present invention. The image display device is utilized in transmission display devices, particularly in displays of televisions, computers, word processors and the like. Among others, the image display device is used on the surface of displays for high-definition images such as CRTs and liquid crystal panels.

When the image display device according to the present invention is a liquid crystal display device, light emitted from the light source device is applied through the lower side of the optical laminate according to the present invention. In STN-type liquid crystal display devices, a phase difference plate may be inserted into between the liquid crystal display element and the polarizing plate. If necessary, an adhesive layer may be provided between individual layers in the liquid crystal display device.

### EXAMPLES

The following Examples further illustrate the present invention. However, it should be noted that the contents of the present invention are not limited by these Examples.

### Preparation of Compositions for Hard Coat Layer

The following components were mixed together while stirring according to the following formulation, and the mixture was filtered to prepare a composition for a hard coat layer. In the formulation, when the contamination preventive agent contains a reactive group, the term “reactive” was appended. On the other hand, when the contamination preventive agent is free from any reactive group, the term “nonreactive” was appended.

Composition 1 for hard coat layer

| | | |
|---|---|---|
| Urethane acrylate | 9.5 | pts. wt. |
| (weight average molecular weight 2000, | | |
| decafunctional; UV1700B; manufactured | | |
| by Nippon Synthetic Chemical Industry | | |
| Co., Ltd.) | | |
| Silicone contamination preventive agent: reactive | 0.5 | pt. wt. |
| (weight average molecular weight 2470; | | |
| SUA1900L6; manufactured by | | |
| Shin-Nakamura Chemical Co., Ltd.) | | |
| Polymerization initiator | 0.4 | pt. wt. |
| (Irgacure 184: manufactured by Ciba | | |
| Specialty Chemicals, K.K.) | | |
| Methyl ethyl ketone | 15 | pts. wt. |

Composition 2 for hard coat layer

| | | |
|---|---|---|
| Urethane acrylate | 9.9 | pts. wt. |
| (weight average molecular weight 2000; | | |
| UV1700B; manufactured by Nippon | | |
| Synthetic Chemical Industry Co., Ltd.) | | |
| Silicone contamination preventive agent: reactive | 0.1 | pt. wt. |
| (weight average molecular weight 2470; | | |
| SUA1900L6; manufactured by | | |
| Shin-Nakamura Chemical Co., Ltd.) | | |
| Polymerization initiator | 0.4 | pt. wt. |
| (Irgacure 184: manufactured by Ciba | | |
| Specialty Chemicals, K.K.) | | |
| Methyl ethyl ketone | 15 | pts. wt. |

Composition 3 for hard coat layer

| | | |
|---|---|---|
| Urethane acrylate | 5.0 | pts. wt. |
| (weight average molecular weight 2000; | | |
| UV1700B; manufactured by Nippon | | |
| Synthetic Chemical Industry Co., Ltd.) | | |
| Silicone contamination preventive agent: reactive | 5.0 | pts. wt. |
| (weight average molecular weight 2470; | | |
| SUA1900L6; manufactured by | | |
| Shin-Nakamura Chemical Co., Ltd.) | | |
| Polymerization initiator | 0.4 | pt. wt. |
| (Irgacure 184: manufactured by Ciba | | |
| Specialty Chemicals, K.K.) | | |
| Methyl ethyl ketone | 15 | pts. wt. |

Composition 4 for hard coat layer

| | | |
|---|---|---|
| Dipentaerythritol hexaacrylate | 9.5 | pts. wt. |
| (hexafunctional, DPHA) | | |
| Silicone contamination preventive agent: reactive | 0.5 | pt. wt. |
| (weight average molecular weight 2470; | | |
| SUA1900L6; manufactured by | | |
| Shin-Nakamura Chemical Co., Ltd.) | | |
| Polymerization initiator | 0.4 | pt. wt. |
| (Irgacure 184: manufactured by Ciba | | |
| Specialty Chemicals, K.K.) | | |
| Methyl ethyl ketone | 15 | pts. wt. |

Composition 5 for hard coat layer

| | | |
|---|---|---|
| Urethane acrylate | 9.5 | pts. wt. |
| (weight average molecular weight 2000; | | |
| UV1700B; manufactured by Nippon | | |
| Synthetic Chemical Industry Co., Ltd.) | | |
| Silicone contamination preventive agent: reactive | 0.5 | pt. wt. |
| (weight average molecular weight 2470; | | |
| SUA1900L6; manufactured by | | |
| Shin-Nakamura Chemical Co., Ltd.) | | |
| Polymerization initiator | 0.4 | pt. wt. |
| (Irgacure 184: manufactured by Ciba | | |
| Specialty Chemicals, K.K.) | | |
| Methyl acetate | 15 | pts. wt. |

Composition 6 for hard coat layer

| | | |
|---|---|---|
| Urethane acrylate | 9.5 | pts. wt. |
| (weight average molecular weight 2000; | | |
| UV1700B; manufactured by Nippon | | |
| Synthetic Chemical Industry Co., Ltd.) | | |
| Silicone contamination preventive agent: reactive | 0.5 | pt. wt. |
| (weight average molecular weight | | |
| 2000 to 10000; UT3971; manufactured | | |
| by Nippon Synthetic Chemical Industry | | |
| Co., Ltd.) | | |
| Polymerization initiator | 0.4 | pt. wt. |
| (Irgacure 184: manufactured by Ciba | | |
| Specialty Chemicals, K.K.) | | |
| Methyl ethyl ketone | 15 | pts. wt. |

Composition 7 for hard coat layer

| | | |
|---|---|---|
| Urethane acrylate | 9.5 | pts. wt. |
| (weight average molecular weight 2000; | | |
| UV1700B; manufactured by Nippon | | |
| Synthetic Chemical Industry Co., Ltd.) | | |
| Fluorine contamination preventive agent: reactive | 0.5 | pt. wt. |
| (weight average molecular weight | | |
| 1000 to 50000; Diffencer TF3000; | | |
| manufactured by Dainippon Ink and | | |
| Chemicals, Inc.) | | |
| Polymerization initiator | 0.4 | pt. wt. |
| (Irgacure 184: manufactured by Ciba | | |
| Specialty Chemicals, K.K.) | | |
| Methyl ethyl ketone | 15 | pts. wt. |

Composition 8 for hard coat layer

| | | |
|---|---|---|
| Urethane acrylate | 9.5 | pts. wt. |
| (weight average molecular weight 2000; | | |
| UV1700B; manufactured by Nippon | | |
| Synthetic Chemical Industry Co., Ltd.) | | |
| Fluorine contamination preventive agent: reactive | 0.25 | pt. wt. |
| (weight average molecular weight | | |
| 1000 to 50000; Diffencer TF3000; | | |
| manufactured by Dainippon Ink and | | |
| Chemicals, Inc.) | | |
| Silicone contamination preventive agent | 0.25 | pt. wt. |
| (weight average molecular weight | | |
| 2000 to 10000; UT3971; manufactured | | |
| by Nippon Synthetic Chemical Industry | | |
| Co., Ltd.) | | |
| Polymerization initiator | 0.4 | pt. wt. |
| (Irgacure 184: manufactured by Ciba | | |
| Specialty Chemicals, K.K.) | | |
| Methyl ethyl ketone | 15 | pts. wt. |

Composition 9 for hard coat layer

| | | |
|---|---|---|
| Urethane acrylate | 9.5 | pts. wt. |
| (weight average molecular weight 2000; | | |
| UV1700B; manufactured by Nippon | | |
| Synthetic Chemical Industry Co., Ltd.) | | |
| Fluorine contamination preventive agent: nonreactive | 0.5 | pt. wt. |
| (weight average molecular weight | | |
| 1000 to 100000; Megafac F178K; | | |
| manufactured by Dainippon Ink and | | |
| Chemicals, Inc.) | | |
| Polymerization initiator | 0.4 | pt. wt. |
| (Irgacure 184: manufactured by Ciba | | |
| Specialty Chemicals, K.K.) | | |
| Toluene | 15 | pts. wt. |

Composition 10 for hard coat layer

| | | |
|---|---|---|
| Polyethylene glycol diacrylate | 9.5 | pts. wt. |
| (weight average molecular weight 302, | | |
| difunctional; M240; manufactured by | | |
| TOAGOSEI CO., LTD.) | | |
| Silicone contamination preventive agent: nonreactive | 0.5 | pt. wt. |
| (weight average molecular weight | | |
| 1000 to 50000; TSF4460; | | |
| manufactured by GE Toshiba Silicones) | | |
| Polymerization initiator | 0.4 | pt. wt. |
| (Irgacure 184: manufactured by Ciba | | |
| Specialty Chemicals, K.K.) | | |
| Toluene/xylene = 1/1 | 15 | pts. wt. |

Composition 11 for hard coat layer

| | | |
|---|---|---|
| Urethane acrylate | 9.5 | pts. wt. |
| (weight average molecular weight 2000; | | |
| UV1700B; manufactured by Nippon | | |
| Synthetic Chemical Industry Co., Ltd.) | | |
| Fluorine contamination preventive agent: nonreactive | 0.5 | pt. wt. |
| (weight average molecular weight | | |
| 20000 to 200000; MCF350; | | |
| manufactured by Dainippon Ink and | | |
| Chemicals, Inc.) | | |
| Polymerization initiator | 0.4 | pt. wt. |
| (Irgacure 184: manufactured by Ciba | | |
| Specialty Chemicals, K.K.) | | |
| Toluene | 15 | pts. wt. |

Composition 12 for hard coat layer

| | | |
|---|---|---|
| Urethane acrylate | 9.5 | pts. wt. |
| (weight average molecular weight 2000; | | |
| UV1700B; manufactured by Nippon | | |
| Synthetic Chemical Industry Co., Ltd.) | | |
| Polymerization initiator | 0.4 | pt. wt. |
| (Irgacure 184: manufactured by Ciba | | |
| Specialty Chemicals, K.K.) | | |
| Toluene/xylene = 1/1 | 15 | pts. wt. |

Composition 13 for hard coat layer

| | | |
|---|---|---|
| Urethane acrylate | 9.9999 | pts. wt. |
| (weight average molecular weight 2000; | | |
| UV1700B; manufactured by Nippon | | |
| Synthetic Chemical Industry Co., Ltd.) | | |
| Silicone contamination preventive agent: reactive | 0.0001 | pt. wt. |
| (weight average molecular weight 2470; | | |
| SUA1900L6; manufactured by | | |
| Shin-Nakamura Chemical Co., Ltd.) | | |
| Polymerization initiator | 0.4 | pt. wt. |
| (Irgacure 184: manufactured by Ciba | | |
| Specialty Chemicals, K.K.) | | |
| Toluene | 15 | pts. wt. |

Composition 14 for hard coat layer

| | | |
|---|---|---|
| Urethane acrylate | 0.0001 | pt. wt. |
| (weight average molecular weight 2000; | | |
| UV1700B; manufactured by Nippon | | |
| Synthetic Chemical Industry Co., Ltd.) | | |
| Silicone contamination preventive agent: reactive | 9.9999 | pts. wt. |
| (weight average molecular weight | | |
| 1000 to 10000; Ebecryl 1360; | | |
| manufactured by Daicel UCB Co.) | | |
| Polymerization initiator | 0.4 | pt. wt. |
| (Irgacure 184: manufactured by Ciba | | |
| Specialty Chemicals, K.K.) | | |
| Toluene/xylene = 1/1 | 15 | pts. wt. |

### Preparation of Optical Laminate

### Example 1

An 80 μm-thick triacetylcellulose film (TAC) was provided as a light transparent base material. This TAC was coated with composition 1 for a hard coat layer at a coverage of 15 g/m² on a wet basis (6 g/m² on a dry basis). The coated TAC was dried at 50° C. for 30 sec and was irradiated with ultraviolet light at 100 mJ/cm² to produce a desired optical laminate.

### Example 2

A desired optical laminate was produced in the same manner as in Example 1, except that composition 2 for a hard coat layer was used instead of composition 1 for a hard coat layer.

### Example 3

A desired optical laminate was produced in the same manner as in Example 1, except that composition 3 for a hard coat layer was used instead of composition 1 for a hard coat layer.

### Example 4

A desired optical laminate was produced in the same manner as in Example 1, except that composition 4 for a hard coat layer was used instead of composition 1 for a hard coat layer.

### Example 5

A desired optical laminate was produced in the same manner as in Example 1, except that composition 5 for a hard coat layer was used instead of composition 1 for a hard coat layer.

### Example 6

A desired optical laminate was produced in the same manner as in Example 1, except that composition 6 for a hard coat layer was used instead of composition 1 for a hard coat layer.

### Example 7

A desired optical laminate was produced in the same manner as in Example 1, except that composition 7 for a hard coat layer was used instead of composition 1 for a hard coat layer.

### Example 8

A desired optical laminate was produced in the same manner as in Example 1, except that composition 8 for a hard coat layer was used instead of composition 1 for a hard coat layer.

### Comparative Example 1

A desired optical laminate was produced in the same manner as in Example 1, except that composition 9 for a hard coat layer was used instead of composition 1 for a hard coat layer.

### Comparative Example 2

A desired optical laminate was produced in the same manner as in Example 1, except that composition 10 for a hard coat layer was used instead of composition 1 for a hard coat layer.

### Comparative Example 3

A desired optical laminate was produced in the same manner as in Example 1, except that composition 11 for a hard coat layer was used instead of composition 1 for a hard coat layer.

### Comparative Example 4

A desired optical laminate was produced in the same manner as in Example 1, except that composition 12 for a hard coat layer was used instead of composition 1 for a hard coat layer.

### Comparative Example 5

A desired optical laminate was produced in the same manner as in Example 1, except that composition 13 for a hard coat layer was used instead of composition 1 for a hard coat layer.

### Comparative Example 6

A desired optical laminate was produced in the same manner as in Example 1, except that composition 14 for a hard coat layer was used instead of composition 1 for a hard coat layer.

Evaluation tests

The optical laminates of Examples and Comparative Examples were subjected to the following evaluation tests, and the results are shown in Table 1 below.

### Evaluation 1: Interference Fringes

In order to prevent the backside reflection of the optical laminate, a black tape was applied to the optical laminate on its side remote from the hard coat layer, and, in this state, the optical laminate was visually observed from the face of the hard coat layer under three-wavelength fluorescence, and the results were evaluated according to the following evaluation criteria.

### Evaluation Criteria

⊚: Interference fringes did not take place in visual observation in all directions.
x: Interference fringes took place in visual observation in all directions.

### Evaluation 2: Hardness

A steel wool #0000 was provided and reciprocated on the surface of the hard coat layer in the optical laminate 10 times for rubbing the hard coat layer while applying a load of 600 g/cm², and the optical laminate was inspected for the presence of scratches.

Evaluation criteria
⊚: No scratch was observed.
x: Scratches were observed.

### Evaluation 3: Contamination Preventive Property

The contact angle of the face of the hard coat layer in the optical laminate with water and an artificial fingerprint liquid (JIS K 2246).

The artificial fingerprint liquid (JIS K 2246): a mixture of water (500 ml), methanol (500 ml), sodium chloride (7 g), urea (1 g), and lactic acid (4 g).

Evaluation criteria 1: Contact angle with water
⊚: Contact angle with water of not less than 90°
x: Contact angle with water of less than 90°

Evaluation criteria 2: Contact angle with artificial fingerprint liquid
⊚: Contact angle with artificial fingerprint liquid of not less than 40°
x: Contact angle with artificial fingerprint liquid of less than 40°

### Evaluation 4: Durability

A Bem cotton previously impregnated with 0.1 g of ethanol was reciprocated 30 times on the surface of the hard coat layer in the optical laminate while applying a load of 200 g/cm² to the Bem cotton. Further, the hard coat layer was dried wiped by reciprocating the Bem cotton 20 times while applying a load of 200 g/cm² to the Bem cotton. Thereafter, evaluation was carried out in the same manner and the evaluation criteria as in Evaluation 3: Contamination preventive property.

### Evaluation 5: Substantial Elimination of Interface

In the optical laminate according to the present invention, the interface of the light transparent base material and the hard coat layer has been substantially rendered absent. A specific example of a criterion based on which the “interface is (substantially) absent” is that, when visual observation of the cross section of the optical laminate under a laser microscope shows the presence of interference fringes, the interface is judged to be present, while, when visual observation of the cross section of the optical laminate under a laser microscope shows the absence of interference fringes, the interface is judged to be absent. Specifically, the cross section of the optical laminate was subjected to transmission observation under a confocal laser microscope (LeicaTCS-NT, manufactured by Leica: magnification 500 to 1000 times) to determine whether or not the interface was present, and the results were evaluated according to the following criteria. Regarding specific conditions for observation under a laser microscope, in order to provide a halation-free sharp image, a wet objective lens was used in a confocal laser microscope, and about 2 ml of an oil having a refractive index of 1.518 was placed on an optical laminate, followed by observation to determine the presence or absence of the interface. The oil was used to allow the air layer between the objective lens and the optical laminate to disappear.

Evaluation criteria
⊚: No interface was observed (note 1).
x: Interface was observed (note 2).

Note 1 and note 2
Note 1: In all of Examples of the present invention, as shown in FIG. 1, only the interface of oil face (upper layer)/hard coat layer (lower layer) was observed, and the interface of the hard coat layer and the light transparent base material was not observed.
Note 2: In all of Comparative Examples, as shown in FIG. 2, the interface was observed at the boundary between adjacent layers of oil face (upper layer)/hard coat layer (middle layer)/light transparent base material (lower layer).

Table 1

TABLE 1

| | Evalu- | Evalu- | | | Evalu- | |
|---|---|---|---|---|---|---|
| | ation | ation | Evaluation 3 | | ation | Evalu- |
| | 1 | 2 | 1) | 2) | 4 | ation 5 |
| Ex. 1 | ⊚ | ⊚ | ⊚ | ⊚ | ⊚ | ⊚ |
| Ex. 2 | ⊚ | ⊚ | ⊚ | ⊚ | ⊚ | ⊚ |
| Ex. 3 | ⊚ | ⊚ | ⊚ | ⊚ | ⊚ | ⊚ |
| Ex. 4 | ⊚ | ⊚ | ⊚ | ⊚ | ⊚ | ⊚ |
| Ex. 5 | ⊚ | ⊚ | ⊚ | ⊚ | ⊚ | ⊚ |
| Ex. 6 | ⊚ | ⊚ | ⊚ | ⊚ | ⊚ | ⊚ |
| Ex. 7 | ⊚ | ⊚ | ⊚ | ⊚ | ⊚ | ⊚ |
| Ex. 8 | ⊚ | ⊚ | ⊚ | ⊚ | ⊚ | ⊚ |
| Comp. Ex. 1 | ⊚ | ⊚ | X | X | X | X |
| Comp. Ex. 2 | ⊚ | X | X | X | X | X |
| Comp. Ex. 3 | X | ⊚ | X | X | X | X |
| Comp. Ex. 4 | ⊚ | ⊚ | X | X | X | X |
| Comp. Ex. 5 | X | X | X | X | X | X |
| Comp. Ex. 6 | X | X | X | X | X | X |

1. An optical laminate comprising a light transparent base material and a hard coat layer provided on the light transparent base material, wherein
the hard coat layer comprises a resin, a contamination preventive agent, and a penetrating solvent penetrable into the light transparent base material, whereby the interface of the light transparent base material and the hard coat layer has been rendered absent.

2. The optical laminate according to claim 1, wherein the contamination preventive agent is a fluorine-type compound, a silicon-type compound, or a mixture of these compounds.

3. The optical laminate according to claim 1, wherein the contamination preventive agent is a compound having a number average molecular weight of not less than 500 and not more than 100000.

4. The optical laminate according to claim 1, wherein the addition amount of the contamination preventive agent is not less than 0.001 part by weight and not more than 90 parts by weight based on the total weight of the composition for forming the hard coat layer.

5. The optical laminate according to claim 1, wherein the composition for forming the hard coat layer further comprises a trifunctional or higher (meth)acrylate.

6. The optical laminate according to claim 1, wherein the contamination preventive agent further comprises a difunctional or higher (meth)acrylate.

7. The optical laminate according to claim 1, wherein the hard coat layer further comprises an antistatic agent.

8. The optical laminate according to claim 1, for use as an antireflection laminate.

9. A polarizing plate comprising a polarizing element, wherein
an optical laminate according to claim 1 is provided on the surface of the polarizing element so that the surface of the polarizing element faces the optical laminate on its side remote from the anti-dazzling layer.

10. An image display device comprising a transmission display and a light source device for applying light to the transmission display from its backside, wherein
an optical laminate according to claim 1 is provided on the surface of the transmission display.

11. An image display device comprising a transmission display and a light source device for applying light to the transmission display from its backside, wherein
a polarizing plate according to claim 9 is provided on the surface of the transmission display.
